(19) United States
(12) Patent Application Publication
(10) Pub. No.: US 2007/0234799 A1
(43) Pub. Date: Oct. 11, 2007

(54) Cable guide support for cable-guided tank gauge

(76) Inventors: Gregory McGillis, Edmonton (CA); Dan Theriault, Edmonton (CA); Robert Winterford, Beaumont (CA)

Correspondence Address: DINSMORE & SHOHL, LLP, 1900 CHEMED CENTER, 255 EAST FIFTH STREET, CINCINNATI, OH, 45202, US

(21) Appl. No.: 11/652,463

(22) Filed: Jan. 11, 2007

(30) Foreign Application Priority Data
Jan. 13, 2006 (CA) 2,532,849

(51) Int. Cl. G01F 23/30

(52) U.S. Cl. 73/306; 254/389

(57) ABSTRACT

A tank gauge system is provided in one embodiment comprising a float, a cable, an indicator and at least one cable guide support. The float is in a tank containing liquid and moves with it. The cable connects the float to the indicator on the outside through the cable support for communicating the liquid level in the tank. The cable support comprises a body having two side openings merging into a cavity formed on a top portion of the body. A roller is positioned in the cavity, between the two openings and is rotatable about an axis transverse to the direction of cable movement. The roller has a predetermined axial length that is substantially wider than each of the openings so that the cable moving through the openings is urged to maintain contact with the roller. This prevents the cable from coming off the roller and minimizes jamming.

### RELATED APPLICATION

The present application claims priority under 35 U.S.C. §119 of Canadian Patent Application 2,532,849 filed Jan. 13, 2006, the entire disclosure of which is considered as part of the disclosure of the present application and is hereby incorporated by reference herein.

### FIELD OF THE INVENTION

The present invention relates to the field of cable guide supports. More particularly, the present invention relates to the field of cable-guide supports for use in cable-guided mechanical tank gauge systems.

### BACKGROUND

A storage vessel in the form of a tank is commonly used, particularly in the oil and gas industry, for containing liquids and gases. The tank may be equipped with a measuring instrument for determining the amount of liquid in the tank.

The measuring instrument often employed for determining liquid levels in the tank is a mechanical tank gauge. A float is contained in the tank and floats on the liquid. The float is attached to one end of a cable, which is guided by a pulley to the outside of the tank where the other end of the cable is connected to an indicator. Changes in the level of liquid cause the float to move up or down in the tank, which translates to movement of the cable and the indicator to show the new liquid level.

U.S. Pat. No. 5,050,432 issued to Barritt discloses a tank gauge having two pulleys. One of the pulleys is in a sealed housing, while the other pulley is exposed to the outside, on the exterior of the tank. The pulleys are of the conventional grooved-type variety.

There have been problems with this type of design of the pulley for guiding the cable. In particular, the cable has a tendency to rub against the sides of the pulley causing increased wear and slack in the cable over time. This can result in the cable losing contact or slipping off of the pulley. In addition, the configuration of the pulley requires that the cable be aligned centrally in the groove between the two sides for reliable operation. Accordingly, having a two pulley system requires that the pulleys be perfectly aligned with each other and the cable, otherwise the cable will not be centered on the pulley. This can cause unreliable operation of the tank gauge since the cable can impinge on the sides of the pulley, or even get jammed between the pulley and the pulley support. Furthermore, one of the pulleys is exposed to outside environmental conditions that can affect the performance of the tank gauge. Dirt, debris, snow or ice on the cable, as a result of being exposed to the environment, can cause jamming or impair operability of the tank gauge.

Canadian Patent 1,321,892, issued to Grimes discloses a tank gauge with a pulley rotatable on a shaft. The cable lies in a groove and contacts side flanges of the pulley. The design of the pulley for the tank gauge of this patent is similar to that of Barritt and therefore suffers from the same drawbacks as mentioned above. In particular, the tank gauge provided by Grimes necessitates the use of a tensioner as reduced tension in the cable greatly increases risk of the cable losing contact or disengaging from the pulley. Also, the pulley is not enclosed and is exposed to the outside, which is a concern since the tank gauge is needed to operate year round.

Accordingly, there is a need for an improved tank gauge system that overcomes certain disadvantages of the prior art.

### SUMMARY

A cable guide support for a tank gauge is provided. In one embodiment, the guide support comprises a body having a top portion, a first side opening at one end and a second side opening at the other end of the body. The top portion has an interior cavity formed therein, which is located between the two openings. The openings extend into the cavity to define a pathway configured to accommodate a cable moving through the pathway. A cable-engaging element is operatively positioned within the cavity between the first and second openings and in communication therewith for guiding the cable. The cable-engaging element is rotatable about an axis transverse to the direction of cable movement and has a predetermined axial length that is substantially wider than each of the openings so that the cable moving through the openings is urged to maintain contact with the cable-engaging element.

In one embodiment, the cable-engaging element includes a roller narrowing in diameter towards its approximate center, which is in alignment with the pathway of the cable moving through the openings.

In another embodiment, the cavity containing the cable-engaging element is enclosed and the side openings provide entrance of the cable onto the cable-engaging element.

In another embodiment, a liquid level tank gauge system comprises a float member, a cable, an indicator mechanism, and at least one cable guide support. The float member is positioned within a tank containing liquid and operable to move with the liquid. The cable has a first end and a second end, the first end being associated with the float member. The second end of the cable is associated with the indicator mechanism, which cooperates with the float member movement to measure the liquid level in the tank. The cable guide support is operatively associated with a portion of the tank, between the float member and the indicator mechanism, for guiding the cable. The cable guide support comprises a body having a top portion, a first side opening at one end and a second side opening at the other end thereof. The top portion forms an interior cavity located between the openings that extend into the cavity to define a pathway configured to allow passage of the cable therethrough. A cable-engaging element is operatively positioned within the pathway for guiding the cable. The cable-engaging element being rotatable about an axis transverse to the direction of cable movement and having a predetermined axial length that is substantially wider than each of the openings so that the cable moving through the openings is urged to maintain contact with the cable-engaging element.

The cable guide support disclosed by at least one embodiment herein is characterized by certain features, in particular:
the openings merge into the cavity containing the cable-engaging element to provide a pathway for guiding the cable;
the cable-engaging element is substantially wider than the openings to prevent the cable from coming off the cable-engaging element and minimizes jamming;
the cable-engaging element narrows in diameter so as to center the cable on it; and
the cable-engaging element is enclosed to reduce debris and foreign materials from interfering with performance of the cable guide support.

A cable guide support is provided in one embodiment, comprising: a body having a top portion, a first side opening at one end and a second side opening at the other end thereof, the top portion forming an interior cavity located between the openings which extend into the cavity to form a pathway configured to accommodate a cable moving therethrough; and a cable-engaging element operatively positioned within the cavity between the first and second openings and in communication therewith for guiding the cable, the cable-engaging element being rotatable about an axis transverse to the direction of cable movement and having a predetermined axial length that is substantially wider than each of the openings so that the cable moving through the openings is urged to maintain contact with the cable-engaging element.

A liquid level tank gauge system is provided in one embodiment, comprising: a float member positioned within a tank containing liquid and operable to move with the liquid; a cable having a first end and a second end, the first end being associated with the float member; an indicator mechanism associated with the second end of the cable and cooperating with the float member movement to measure the liquid level in the tank; and at least one cable guide support operatively associated with a portion of the tank, between the float member and the indicator mechanism, for guiding the cable, the guide support comprising a body having a top portion, a first side opening at one end and a second side opening at the other end thereof, the top portion forming an interior cavity located between the openings which extend into the cavity to form a pathway configured to allow passage of the cable therethrough, and a cable-engaging element operatively positioned within the pathway for guiding the cable, the cable-engaging element being rotatable about an axis transverse to the direction of cable movement and having a predetermined axial length that is substantially wider than each of the openings so that the cable moving through the openings is urged to maintain contact with the cable-engaging element.

### BRIEF DESCRIPTION OF THE DRAWINGS

FIG. 1 is a side elevational view depicting a tank gauge system according to one embodiment;

FIG. 2 is a front elevational view depicting an indicator mechanism of the tank gauge system of FIG. 1;

FIG. 3 is an exploded perspective view depicting a cable guide support according to one embodiment;

FIG. 4 is a top plan view depicting the cable guide support of FIG. 3; and

FIG. 5 is a side elevational view depicting the cable guide support of FIG. 3.

### DETAILED DESCRIPTION OF ILLUSTRATIVE EMBODIMENTS

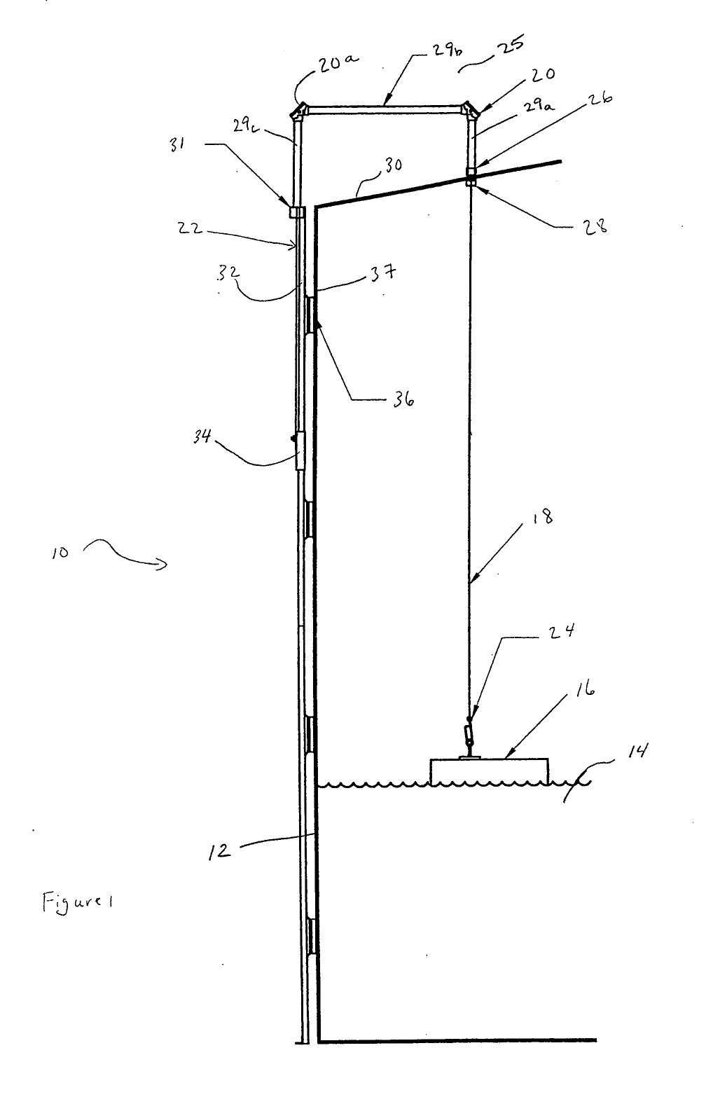

FIG. 1 illustrates an embodiment of a tank gauge system 10 mounted on tank 12 that contains liquid 14, such as oil, drilling mud, petroleum, water, chemicals or the like. Tank gauge system 10 comprises a float member 16, a cable 18, a cable guide support 20 and an indicator mechanism 22. Float member 16 has a predetermined weight and buoyancy so as to float in liquid 14. Float member 16 follows the change in the level of liquid 14 in tank 12. Design, configuration and material used in construction of float member 16 are known to those skilled in the art. Materials such as corrosive resistant plastics, PVC and metals having particular desirable properties that are resistant to the nature of the liquid 14 can be used.

In a representative embodiment, float member 16 is connected to cable 18, which can be made of stainless steel, through clip 24 that enables float member 16 to be detached, when desired. Other types of connectors, known to those skilled in the art, for connecting float member 16 to cable 18 can be used, such as a swivel (not shown). Cable 18 extends from float member 16 up tank 12, through an adaptor 26 and nut 28 in a top part 30 of tank 12. Cable guide conduit 25 is located on top part 30 of tank 12 and allows communication between float member 16 and indicator mechanism 22 located exterior of tank 12. Cable guide conduit 25 consists of conduit sections 29a, 29b, and 29c, in combination with cable guide supports 20 and 20a to from an inverted U-shaped cable conduit system.

Guide supports 20, 20a are positioned along top part 30 of tank 12 at a predetermined distance from each other, the distance determined by a person skilled in the art having regard to the physical configuration and dimensions of the tank that tank gauge system 10 is being installed on. Each of cable guide supports 20, 20a is mutually aligned with conduit sections 29a, 29b, and 29c. Section 29a has one end mounted to adaptor 26 and section 29c has one end mounted to a clamping block 31 to secure to indicator mechanism 22. This enables free movement of cable 18 between float member 16 and indicator mechanism 22 through cable guide supports 20, 20a.

Indicator mechanism 22 includes a gauge board 32 and an indicator bar 34. Their design and construction is well known to those skilled in the art. While different configurations of gauge board 32 can be fabricated depending on the application, gauge board 32 can generally be made to correspond with tank 12 height. In the embodiment shown in FIG. 1, gauge board 32 can be made from aluminum having a mounting bracket 36 to secure gauge board 32 to a side portion 37 of tank 12. Mounting bracket 36 can be secured to tank 12 using welds, adhesive, magnets or any other means as known by those skilled in the art.

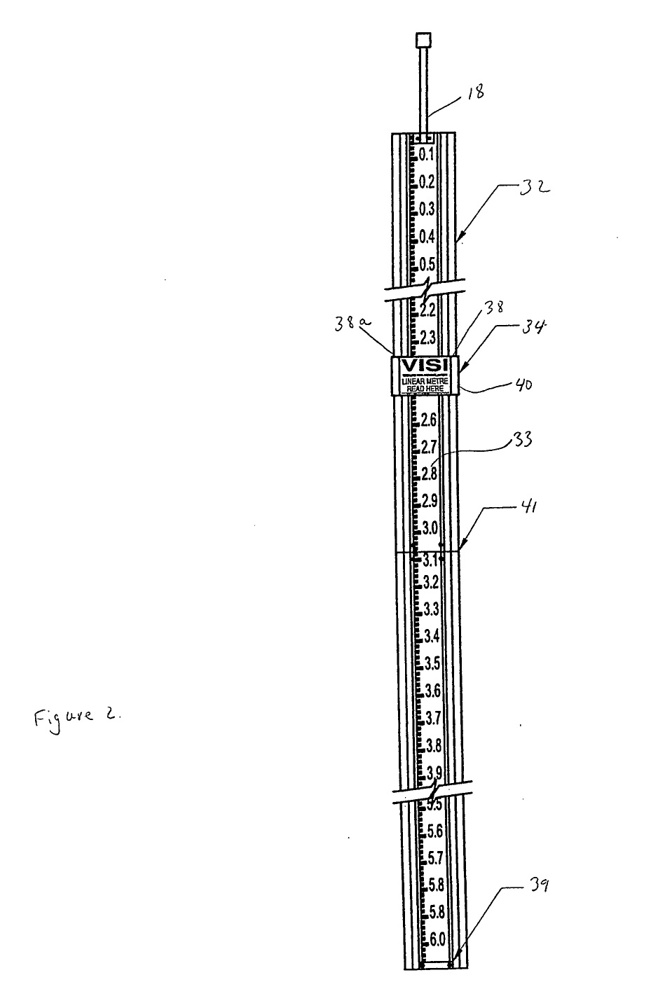

FIG. 2 shows a representative gauge board 32 marked with desired units of measurement 33, depending on the application. In one embodiment, gauge board 32 can be provided in multiple pieces that are joined through board joiners 41 during assembly. Indicator bar 34 is connected to cable 18 and slides along gauge board 32 corresponding to the level of liquid in tank 12, as indicated by changes in position of float member 16 within tank 12. Guides 38, 38a are fitted to an inside portion 40 of indicator bar 34 to enable it to glide smoothly along gauge board 32. In one embodiment, guides 38, 38a can be made from plastic, or coated with teflon, all known to those skilled in the art. In a representative embodiment, gauge board 32 can have bottom bracket 39 for limiting the movement of indicator bar 34.

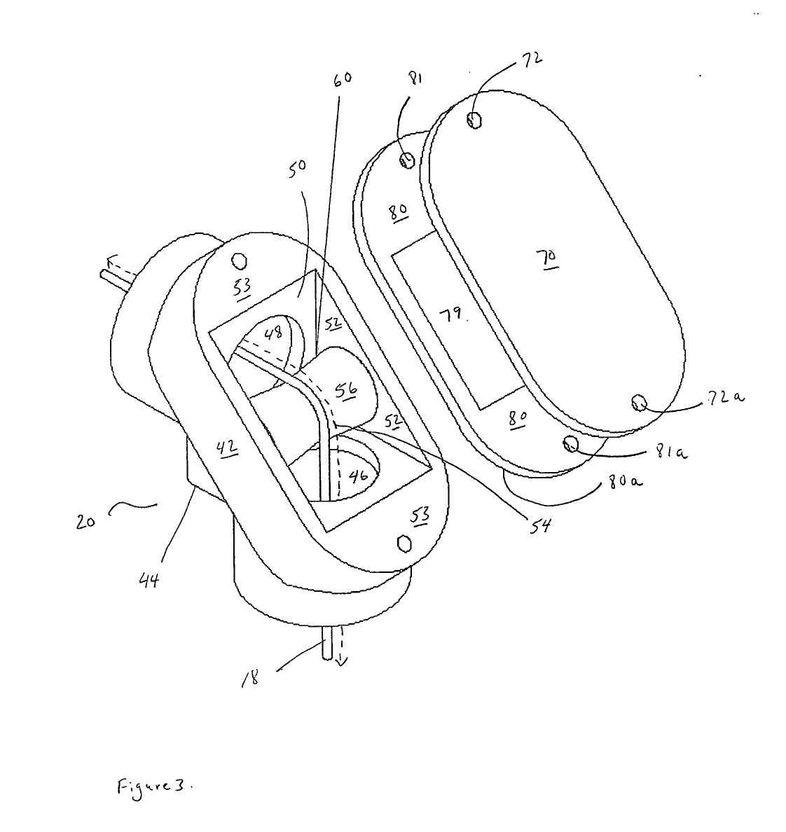

Referring now to FIG. 3, cable guide support 20 comprising body 42 is shown. In one embodiment, body 42 comprises elbow 44 having a first side opening 46 and a second side opening 48. In a representative embodiment, body 42 is constructed from PVC. The two openings 46, 48 lead into cavity 50 having sidewalls 52 that slope downwardly from top portion 53 of body 42 towards its interior. Pathway 54 extends between one side opening 46, cavity 50 and the other side opening 48. Openings 46, 48 are mutually aligned along pathway 54 for accepting cable 18. Pathway 54 is configured to accommodate differently sized cables 18. Top portion 53 of body 42 is planar with cavity 50 formed generally at the center of body 42 as representatively illustrated in FIG. 3.

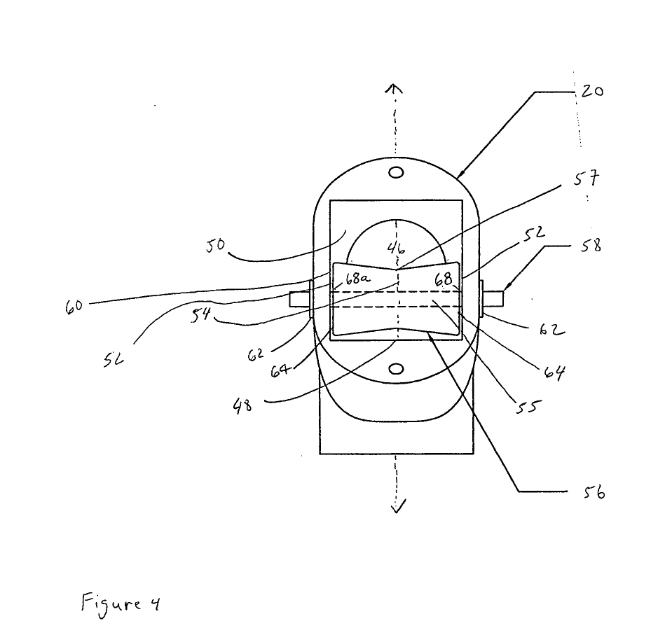

As shown in FIG. 4, a cable-engaging element is operatively positioned in cavity 50 between openings 46, 48 so as to guide cable 18 moving in pathway 54. In one embodiment, the cable-engaging element can be roller 56. Roller 56 can be a cylindrical member, or the like, having bore 55 for receiving axle 58 that extends across lower part 60 of cavity 50. Roller 56 is freely rotatable on axle 58. In one embodiment, axle 58 is secured to sidewalls 52 of cavity 50 using locking washer 62. Other means for securing axle 58 to sidewalls 52 known to those skilled in the art can be used, such adhesive, locking mechanism, or plastic weld.

Roller 56 includes planar end surfaces 64. The width of roller 56 is selected such that it is slightly narrower than the width of cavity 50. This allows end surfaces 64 to be in close proximity to opposing sidewalls 52 while not impeding free rotation of the roller 56 on axle 58. In one embodiment, roller 56 narrows in diameter from each of its ends towards its approximate center 57 that is in alignment with pathway 54. The axial length of roller 56 is substantially wider than each of openings 46, 48, when viewed through the openings, so that cable 18 is prevented from slipping between end surfaces 64 and sidewalls 52.

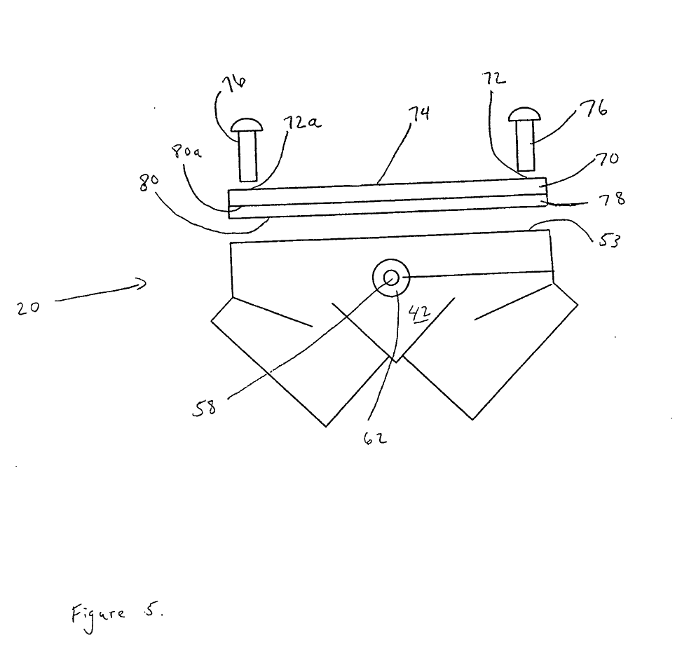

Referring now to FIG. 5, one embodiment of cable guide support 20 is shown including lid 70. Lid 70 includes holes 72, 72a passing through top surface 74 for fasteners 76 to pass therethrough and secure lid 70 to top portion 53 of body 42. As shown in FIGS. 3 and 5, sealing element 78 is provided to provide a seal between lid 70 and top portion 53. Sealing element 78 can be a rubberized washer or a gasket. Sealing element 78 includes rectangular opening 79, mating surfaces 80, 80a and holes 81, 81a. Sealing element 78 is sandwiched between lid 70 and top portion 53 when fasteners 76 are secured to body 42. Although lid 70 is provided in this embodiment as a separate element for enclosing cavity 50, it should be obvious to one skilled in the art that body 42 can be fabricated as a sealed, one-piece unit having side openings 46, 48 and roller 56 mounted in cavity 50 within body 42.

Although a few embodiments have been shown and described, it will be appreciated by those skilled in the art that various changes and modifications might be made without departing from the scope of the invention. The terms and expressions used in the preceding specification have been used herein as terms of description and not of limitation, and there is no intention in the use of such terms and expressions of excluding equivalents of the features shown and described or portions thereof, it being recognized that the scope of the invention is defined and limited only by the claims that follow.

What is claimed is:

1. A cable guide support, comprising:
a) a body having a top portion, a first side opening at one end and a second side opening at the other end thereof, the top portion forming an interior cavity located between the openings which extend into the cavity to form a pathway configured to accommodate a cable moving therethrough; and
b) a cable-engaging element operatively positioned within the cavity between the first and second openings and in communication therewith for guiding the cable, the cable-engaging element being rotatable about an axis transverse to the direction of cable movement and having a predetermined axial length that is substantially wider than each of the openings so that the cable moving through the openings is urged to maintain contact with the cable-engaging element.

2. The cable guide support as set forth in claim 1 wherein the cable-engaging element narrows in diameter towards its approximate centre and is in alignment with the pathway of the cable moving through the openings.

3. The cable guide support as set forth in claim 2 wherein the cable-engaging element comprises a roller having a bore extending therethrough for receiving an axle, the roller being freely rotatable on the axle securely positioned at a lower part of the cavity extending thereacross, from one sidewall to the opposite sidewall, the roller having opposing side surfaces configured to lie sufficiently close against the sidewalls while not impeding rotation of the roller on the axle.

4. The cable guide support as set forth in claim 1 further comprising a lid associated with the body and being configured to engage with the top portion to enclose the cavity within the body.

5. The cable guide support as set forth in claim 4 further comprising a fastener for removably securing the lid to the top portion of the body.

6. The cable guide support as set forth in claim 4 further comprising a sealing element sealingly positioned between the top portion of the body and the lid.

7. The cable guide support as set forth in claim 6 wherein the sealing element is a rubberized washer or gasket having mating surfaces conforming to the top portion of the body and the lid.

8. The cable guide support as set forth in claim 4 wherein the body and the lid are a one-piece construction.

9. A liquid level tank gauge system, comprising:
a) a float member positioned within a tank containing liquid and operable to move with the liquid;
b) a cable having a first end and a second end, the first end being associated with the float member;
c) an indicator mechanism associated with the second end of the cable and cooperating with the float member movement to measure the liquid level in the tank; and
d) at least one cable guide support operatively associated with a portion of the tank, between the float member and the indicator mechanism, for guiding the cable, the guide support comprising:
i) a body having a top portion, a first side opening at one end and a second side opening at the other end thereof, the top portion forming an interior cavity located between the openings which extend into the cavity to form a pathway configured to allow passage of the cable therethrough, and
ii) a cable-engaging element operatively positioned within the pathway for guiding the cable, the cable-engaging element being rotatable about an axis transverse to the direction of cable movement and having a predetermined axial length that is substantially wider than each of the openings so that the cable moving through the openings is urged to maintain contact with the cable-engaging element.

10. The liquid level tank gauge system as set forth in claim 9 wherein the indicator mechanism is sufficiently weighted such that the cable is taut and freely moveable on the cable guide support.

11. The liquid level tank gauge system as set forth in claim 10 wherein the indicator mechanism includes a gauge board mounted along a sidewall of the tank and an indicator bar configured to slide along the gauge board.

12. The liquid level tank gauge system as set forth in claim 9 wherein the cable guide support is mounted on a portion of the tank at a predetermined distance from the float member and a second cable guide support is aligned therewith.

13. The liquid level tank gauge system as set forth in claim 11 wherein the gauge board is mounted using a magnetic bracket for releasably coupling the gauge board to the sidewall of the tank.

14. The liquid level tank gauge system as set forth in claim 11 wherein the gauge board is mounted to the tank sidewall with a welded bracket.
